(19) United States
(12) Patent Application Publication
(10) Pub. No.: US 2007/0136813 A1
(43) Pub. Date: Jun. 14, 2007

(54) Method for eliminating invalid intrusion alerts

(76) Inventor: Hsing-Kuo Wong, Lung-Tan Township (TW)

Correspondence Address: J.C. Patents, Inc.;Suite 250, 4 Venture, Irvine, CA, 92618, US

(21) Appl. No.: 11/298,021

(22) Filed: Dec. 8, 2005

(51) Int. Cl. G06F 12/14

(52) U.S. Cl. 726/25

(57) ABSTRACT

The method for eliminating invalid intrusion alerts operates according to a set of filter rules that are generated from given firewall rules. As a filter that implements this method receives an intrusion alert, it directly matches the features of the alert against its own rules, and then decides the validity of the alert. By coupling with the method, various filter-rule sets could be generated for numerous firewalls that may be not on the same specification, and an on-line deployment method could be applied to deploy filter-rule sets for filters. By applying the invention, it is reachable to eliminate invalid intrusion alerts precisely and efficiently, and to deploy quickly and with less manpower.

### BACKGROUND OF THE INVENTION

1. Field of the Invention

The present invention is related to a method for processing alerts, and more particularly, to a method for eliminating invalid intrusion alerts by using firewall rules to determine the validity of intrusion alerts.

2. Description of the Related Art

Since the number of network attacks is continuously growing, information security has become a very important issue now. Wherein, intrusion detection system (IDS) and firewall (FW) are the most popular detection and protection systems used in current industry. Usually, an IDS is designed to detect network attacks, abnormal actions, policy-violation or unusual behaviors by matching misuse signature. For example, an IDS could detect malicious attacks, such as Unicode attack to the Microsoft Internet Explorer, abnormal access to web page (e.g. accessing to ..\..\winnt\bin), downloading large amount of multimedia files by using P2P software, or attempting to continuously logon a web page on a web server. A firewall is mainly used as a gateway to control network access between an Intranet and the Internet or between two Intranets. For example, a firewall could be configured to reject all access to internal hosts from the external, or configured to allow external access for browsing public web servers in DMZ (demilitarized zone) only.

FIG. 1 schematically shows a structure diagram of a conventional IDS and FW. Referring to FIG. 1, in conventional methods for protecting the network from malicious attacks, a firewall 140 is commonly disposed between a plurality of hosts 110 in an internal network and a router 130 connected to an external network 120. The firewall 140 is configured to detect and block malicious attacks from the external network. In addition, a first IDS 150 is further disposed between the router 130 and the firewall 140 to detect all malicious attacks against the internal network from the external network. Alternatively, a second IDS 160 may be disposed between the hosts 110 and the firewall 140 to detect all malicious attacks against the external network from the internal network. The intrusion alerts caused by malicious attacks detected by the first or second IDS are transmitted to a security operation center for further analysis by security officers, and for further incident handling based on analysis result.

Although IDSes are capable of detecting hacker's attacks and threat caused by malicious codes, the IDS industry now is facing a significant problem that IDSes usually generate a great amount of invalid alerts. Such alerts are often caused due to detecting malicious activities or network packets by IDSes. According to the fact how a network packet passes through a firewall, intrusion alerts can be classified into four different types. For example, please refer to FIG. 1. These cases are: (1) The network packet comes from the external network 120 and is rejected and then blocked by the firewall 140. In this case the IDS 150 detects it and generates an alert. (2) The network packet comes from the internal network 110 and is rejected and then blocked by the firewall 140. In this case the IDS 160 detects it and generates an alert. (3) The network packet comes from the external network 120 and is accepted and hence passed by the firewall 140. In this case the IDS 150 detects it and generates an alert. (4) The network packet comes from the internal network 120 and is accepted and passed by the firewall 140. In this case the IDS 160 detects it and generates an alert. Note that the network packet fails in passing through the firewall 140 in the first two cases. Thus a hacker or one having malicious intention have no way to complete their attacks or policy-violation activity, therefore the caused intrusion alerts should be regarded as invalid. On the other hand, the network packets succeed in passing through the firewall 140 in the last two cases, therefore such network attacks or policy-violation activity should be focused and dealt with, and the caused intrusion alerts also should be transmitted to a security operation center for security officers to further analyze and handle.

Currently, it is a very common usage that an enterprise or organization deploy a firewall at the place of entering their internal network. So various network attacks or policy-violation activities can be effectively blocked by their firewalls as long as the firewall rules are appropriately set. Although most of behaviors that may negatively threat network security are blocked by the firewalls, such behaviors are still detected by the deployed IDSes, and a great amount of intrusion alerts are generated accordingly. Referring to the first two cases mentioned above, the intrusion alerts generated in such cases should be regarded as invalid. Since the security operation center usually needs to manage many firewalls and IDSes that are deployed in different sites, a great amount of intrusion alerts are therefore transmitted to the security operation center self, and most of them are invalid.

The great amount of invalid alerts inevitably wastes the resources spent in handling them in the security operation center, or even in some cases the real attack or threaten may be masked by them. The current solution is to have the security operation center receive firewall logs, and determine the invalidity of an alert by checking firewall logs. An alert will be determined as invalid if the network packet causing it is found in the firewall logs and rejected by the firewall; otherwise it will be regarded as valid. In other words, in order to eliminate invalid intrusion alerts, a security operation center has to receive and compare firewall logs for determining whether an alert is valid or not.

Although the method mentioned above can eliminate invalid intrusion alerts, it is obvious that the method has following disadvantages.

1. It consumes a great amount of network bandwidth. Since the amount of firewall logs is usually huge, the way of receiving firewall logs obviously consumes a large amount of network bandwidth. For the case that firewall logs need to be on-line transmitted to a security operation center, it may cause very serious network congestion. Even if the transmission of firewall logs is adopted to be in periodical and off-line mode instead, a significant amount of network bandwidth is also consumed.

2. It is too late for determining the invalidity of an alert. The way that a security operation center determines the invalidity of alerts is not instantaneous obviously. Even if firewall logs are on-line transmitted, the way for a security operation center to determine an ongoing network attack may be too late. For example, the conventional method is not suitable for a security center to immediately block an intrusion connection of an ongoing attack fired by a hacker using an automatic tool.

3. It may cause a security operation center to misjudge the invalidity of alerts. Notice that logging the acceptance or rejection of a network packet is one of conventional options of a firewall rule. It means that when a network packet matches a firewall rule, the firewall will not record the decision of accepting or rejecting the network packet while the rule is not set to log. If a firewall is not configured to log the decision correctively, there is no records found in its logs regarding that network packet. This fact will lead a security operation center to determine the invalidity of alerts incorrectly.

4. The feasibility of the conventional method is rather poor. In the conventional method of the firewall integration, it is to prevent a security operation center from misjudging the validity of alerts that a firewall administrator has to design the firewall rules strictly and carefully. However a perfect setting of firewall rules is really impractical because potential human errors in setting are usually possibly caused. Even though the configuration of firewall rules is supposed sound and completed, a security operation center is still hard to ensure owning complete firewall logs. The reasons are due to the facts that many firewall logs may be abandoned because of limited capacity of network bandwidth or insufficient capacity of hard drive in a firewall. In other words, the feasibility of the conventional method is rather poor.

5. It confines alert correlation performed in a security operation center. Since the conventional method is confined by the size of the firewall log and the limited timeliness, it is common in the prior art that the validity of alerts is usually determined by a security operation center after the alerts is correlated. However, since the amount of invalid alerts is very huge, the efforts and resources of correcting and handling invalid alerts are indeed wasted.

### SUMMARY OF THE INVENTION

Therefore, it is an objective of the present invention to provide a method for eliminating invalid intrusion alerts. In this method, a plurality of firewall rules in a firewall is converted into a filter rule set, and an alert filter directly compares the features of an intrusion alert with the filter rule set to determine whether there are matched filter rules. Accordingly, the invalid intrusion alerts are found and further filtered.

It is another objective of the present invention to provide an on-line method for deploying the filter rule sets. In this method, the information of a plurality of firewall, IDSes, and alert-collection hosts are registered in a security control center. When there is a change on the managed firewall rule, the security operation center will generate the corresponding filter rule sets, which are then deployed in the alert filter of the corresponding alert-collection hosts through the network, such that the filter rule sets are deployed quickly and with less manpower.

The present invention provides a method for eliminating invalid intrusion alerts. The method comprises the following steps. First, a plurality of firewall rules is recorded in a database, and the recorded firewall rules are converted into a filter rule set, which is then recorded in an alert filter. When the alert filter receives an intrusion alert, a plurality of alert features is extracted. Next, whether the IDS generating such alert is cooperated with the firewall to protect the same network is determined. If it is, whether there are the alert features matched with the firewall rules is further determined. If there are firewall rules matched, the validity of the intrusion alert is determined according to the matched firewall rule. Otherwise, the intrusion alert is determined as invalid, and finally, the invalid intrusion alert is filtered.

In the method for eliminating the invalid intrusion alerts according to a preferred embodiment of the present invention, wherein after determining whether there are alert features matched with the filter rules, the method further determines whether there are more than one filter rules matched. If there are more than one filter rules matched with the alert features, the filter rule with the highest priority among the matched filter rules is used to determine the validity of the intrusion alert. If there is only one rule matched, the validity of the intrusion alert is determined according to the matched filter rule.

In the method for eliminating the invalid intrusion alerts according to the preferred embodiment of the present invention, wherein the step of applying the matched rule to determine the validity of the intrusion alert comprises: if the intrusion alert is rejected by the filter rule, the intrusion alert is determined as invalid, and if the intrusion alert is accepted by the filter rule, the intrusion alert is determined as valid.

In the method for eliminating the invalid intrusion alerts according to the preferred embodiment of the present invention, wherein the step of determining whether the IDS generating such alert is cooperated with the firewall to protect the same network comprises: if the intrusion alert is an alert generated by a predetermined IDS, it is determined as “Yes”, otherwise, it is determined as “No”.

In the method for eliminating the invalid intrusion alerts according to the preferred embodiment of the present invention, wherein the step of converting the firewall rules of a firewall into a filter rule set comprises extracting the communication protocol, the source IP address, the destination IP address, the source network service port, the destination network service port, the time, and the acceptance, rejection, and priority information from each firewall rule, so as to form a corresponding filter rule, and combining the generated filter rule with the ID of the firewall to form the filter rule set.

In the method for eliminating the invalid intrusion alerts according to the preferred embodiment of the present invention, wherein the alert feature comprises the ID of the IDS, the communication protocol, the source IP address, the destination IP address, the source network service port, the destination network service port, and the time.

The present invention provides an on-line method for deploying the filter rule sets. The method is suitable for a security operation center to deploy a plurality of filter rule sets into multiple alert-collection hosts in the remote sites. The method records a plurality of firewalls, the IDS, and the ID of the alert-collection hosts managed by the security operation center in a registration table. Then, a plurality of firewall rules of the firewall in a database is recorded. Next, the firewall rules for each firewall are converted into a filter rule set and the filter rule set is recorded in the database. Finally, the filter rule set is transmitted to the alert filter in the corresponding alert-collection host according to the registration table.

In the on-line method for deploying the filter rule sets according to a preferred embodiment of the present invention, wherein the registration table further comprises the functions such as recording a relationship of whether the firewalls are cooperated with the IDS to protect the same network, and recording the information of which IDS generating the alerts are received by the alert-collection host.

In the on-line method for deploying the filter rule sets according to the preferred embodiment of the present invention, wherein the firewall rules are obtained from a firewall that is configured to detect the network attacks.

In the on-line method for deploying the filter rule sets according to the preferred embodiment of the present invention, wherein the step of converting the firewall rules for each firewall to the filter rule set comprises: extracting the communication protocol, the source IP address, the destination IP address, the source network service port, the destination network service port, the time, and the priority information from each firewall rule, so as to form a corresponding filter rule; and combining the generated filter rule with the ID of the firewall to form a filter rule set.

The on-line method for deploying the filter rule sets according to the preferred embodiment of the present invention further comprises: when there is a change on the firewall rule in some firewall, the security operation center will update the filter rule sets.

In the present invention, the firewall rules are applied to form the filter rule set, and the alert filter eliminates the invalid intrusion alerts based on the filter rule set. Accordingly, the present invention can be directly applied in the alert filter of the alert-collection host by the security operation center. When the alert filter receives the intrusion alerts, the alert features are directly compared with the filter rules to determine whether the intrusion alert is valid, so as to avoid the disadvantage of comparing the firewall log in the conventional method.

The present invention can be applied in the security operation center to eliminate invalid intrusion alerts, and even more the invalid intrusion alerts are eliminated directly at the entrance of the system. Therefore, the method does not need to provide firewall log to a security operation center. That significantly saves network bandwidth. In addition, since invalid intrusion alerts are on-line eliminated immediately, a security operation center does not spend its precious resources to process the invalid alerts. Moreover, since the condition of the present invention to eliminate invalid intrusion alerts is complied with the condition of whether the firewall accepts or rejects the attack packets, there is no misjudgment in the present invention as in the conventional method. Furthermore, since the space for storing the required filter rule sets is much smaller than the space for storing the firewall logs, the present invention has higher feasibility.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a structure diagram of a conventional intrusion detection system (IDS) and a firewall (FW).

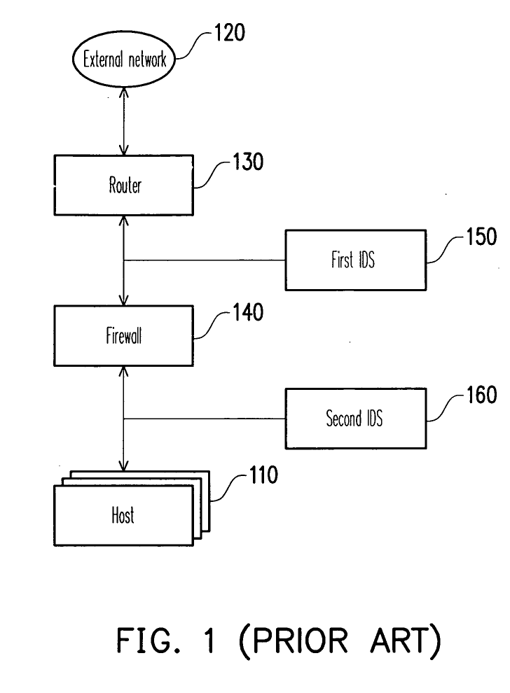

FIG. 2 schematically shows a flow chart illustrating a method for eliminating invalid intrusion alerts according to a preferred embodiment of the present invention.

FIG. 3 schematically shows a bar chart of alerts according to the preferred embodiment of the present invention.

FIG. 4 schematically shows a flow chart illustrating a method for on-line deploying filter rule sets according to a preferred embodiment of the present invention.

### DESCRIPTION PREFERRED EMBODIMENTS

Since a firewall is a gateway for controlling the access between an intranet and the external network (e.g. the internet or another intranet), the network packets blocked by the firewall should not be able to attack the destination computers, thus the IDS alert triggered by it should be an invalid alert.

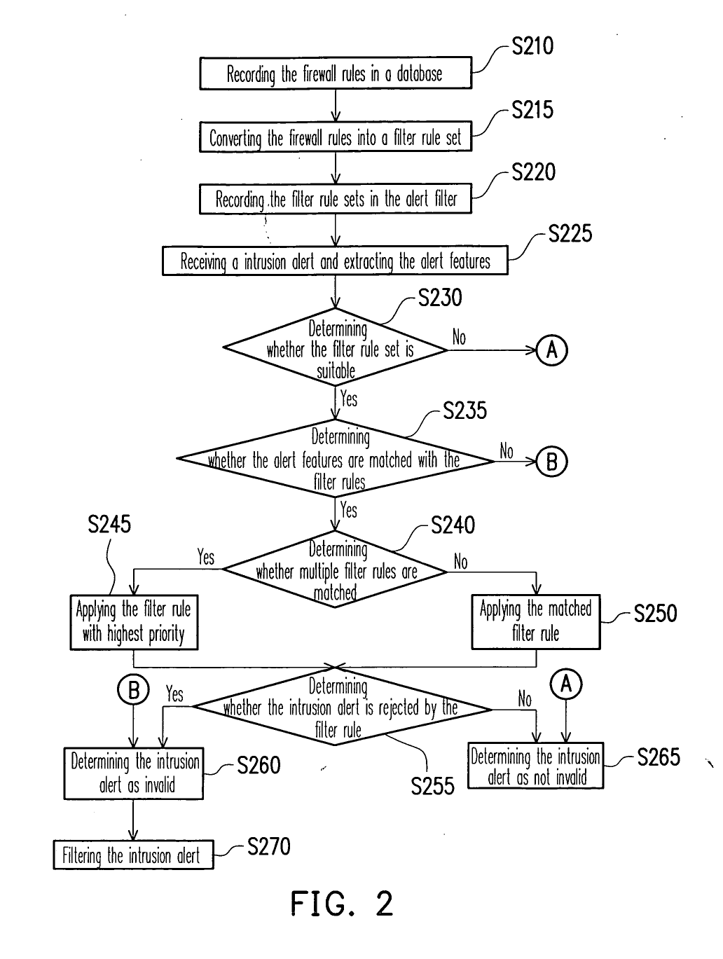

FIG. 2 schematically shows a flow chart illustrating a method for eliminating invalid intrusion alerts according to a preferred embodiment of the present invention. Referring to FIG. 2, in the present embodiment, all of firewall rules in a firewall are recorded in a database to form a filter rule set, such that the alert filter can precisely determine whether the packet triggering the intrusion alert can pass through the firewall or not. Accordingly, a great amount of invalid intrusion alerts are effectively eliminated.

First, all of firewall rules in a firewall are recorded in a database by a host (step S210), wherein the firewall rules are obtained from a firewall, which is disposed between an intranet of a company or an organization and an external network to protect the company or organization from network attacks. Then, the recorded firewall rules are converted into a filter rule set (step S215), wherein each filter rule comprises the communication protocol, the source IP address, the destination IP address, the source network service port, the destination network service port, the time, the acceptance, rejection, and priority information of each corresponding firewall rule, and the filter rule sets are recorded in an alert filter (step S220). Wherein, the alert filter may be installed in an IDS or an alert-collection host of a security operation center according to user's requirements.

When the alert filter receives an intrusion alert, a plurality of alert features are extracted (step S225). Wherein, the alert features may comprise the ID of the IDS, the communication protocol, the source IP address, the destination IP address, the source network service port, the destination network service port, and the time.

Then, the alert filter determines whether to use this filter rule set or not (step S230). Wherein, the determination is based on the fact of whether the IDS is predetermined to be cooperated with the firewall to protect the same network. If it is not, the intrusion alert is not determined as invalid. Otherwise, the process goes to the next step.

Then, the alert filter compares the extracted alert features with the recorded filter rule sets to determine whether the alert features are matched with the filter rule sets (step S235). If none of the filter rules is matched, the intrusion alert is determined as invalid (step S260). If there are matched filter rules, whether multiple filter rules are matched is further determined (step S240). If multiple filter rules are matched, the filter rule with the highest priority is selected (step S245). If only one filter rule is matched, this matched filter rule is selected (step S250).

Finally, whether to reject this intrusion alert is determined based on the filter rule selected in the step S245 or S250. If it is rejected, the intrusion alert is determined as invalid (step S260), and the invalid intrusion alert is filtered (step S270). Otherwise, the intrusion alert is determined as valid (step S265).

With such steps, the intrusion alerts triggered by the network packets originally blocked by the firewall are effectively filtered. In addition, since the filter rules used by the alert filter are complied with the firewall rules, the invalid intrusion alerts are precisely filtered. Moreover, since it is not required to provide and compare the firewall logs, the disadvantage of the conventional method is effectively avoided, and a great amount of network resources and time are reduced.

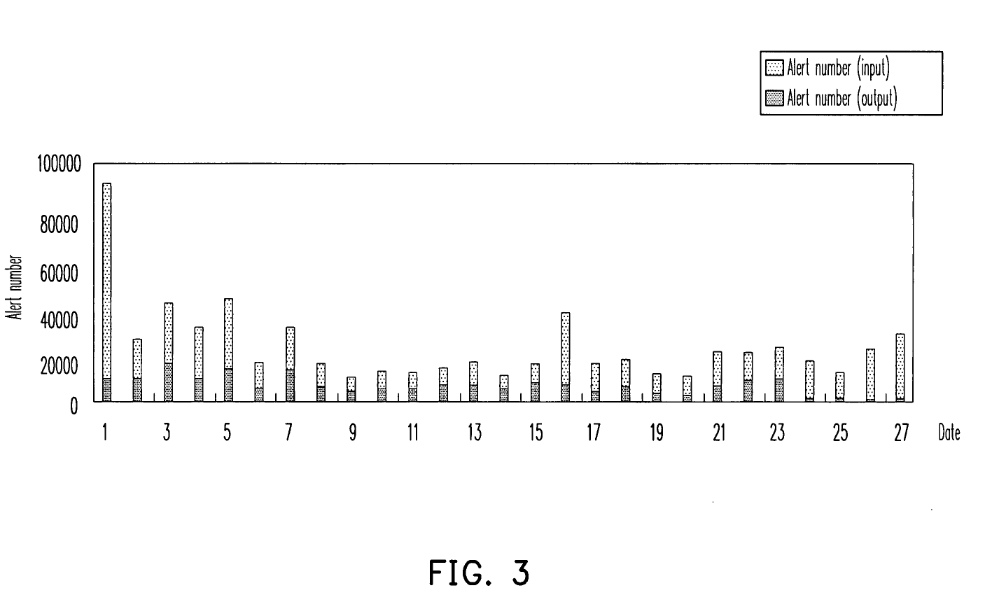

FIG. 3 schematically shows a bar chart of the alerts according to the preferred embodiment of the present invention. Wherein, the X-axis represents the date of the alert counting (it is represented as the n^{th} day), and the Y-axis represents the number of alerts. Referring to FIG. 3, the light color area in the diagram represents the number of alerts originally input into the alert filter, and the dark color area represents the number of alerts output by the alert filter after filtering. As shown in the diagram, after the invalid alerts are filtered by the alert filter of the present invention, the number of alerts is significantly decreased. Accordingly, the present invention can precisely eliminate a great amount of invalid alerts.

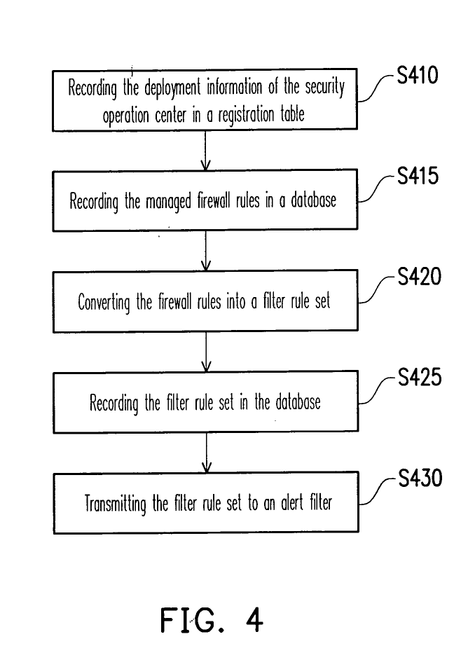

FIG. 4 schematically shows a flow chart illustrating an method for on-line deploying the filter rule sets according to a preferred embodiment of the present invention. Referring to FIG. 4, in the present embodiment, the deployment information and the firewall rules are recorded in a database, and a desired filter rule set is generated when a new alert filter is deployed or the firewall rule is changed. The filter rule sets are on-line transmitted to the corresponding alert filters through the network, such that the alert filter can be quickly deployed with less manpower.

First, the deployment information is recorded in a registration table by a security operation center (step S410). Wherein, the registration table includes the firewalls, the IDS, and the ID of the alert-collection hosts managed by the security operation center. Then, all firewall rules of the managed firewalls are recorded in a database (step S415).

Then, all firewall rules in a firewall selected from the managed firewalls are converted into a filter rule set (step S420). Wherein, the converting is occurred whenever a new alert filter is deployed or the firewall rules are changed. The filter rule set is recorded in a database (step S425). Then, the filter rule set is transmitted to the corresponding alert filter according to the registration table (step S430).

With such method, the staffs in a security operation center can remotely control and update the alert filters located in different sites through the network without asking staffs to go to different sites for updating the alert filters. Accordingly, the alert filters can be quickly deployed with less manpower.

In summary, in the method for eliminating the invalid intrusion alerts provided by the present invention. Filter rule sets are generated from given firewall rules, and applied by the alert filter to eliminate invalid intrusion alerts. When the alert filter receives intrusion alerts, the validity of the alerts is determined through directly comparing the features of the intrusion alerts with the filter rules. In addition, various filter rule sets can be generated corresponding to different firewalls, and on-line deployed in alert filters located in different sites. Accordingly, invalid intrusion alerts can be effectively filtered.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for eliminating invalid intrusion alerts, comprising:
recording a plurality of firewall rules of a firewall in a database;
converting the firewall rules into a filter rule set;
recording the filter rule set in an alert filter;
receiving an intrusion alert, and extracting a plurality of alert features from the intrusion alert;
determining whether the intrusion detection system (IDS) that generates the alert is cooperated with the firewall to protect the same network;
if it is not true, not determining the intrusion alert as invalid, and if it is true, performing the following step;
determining whether the alert features are matched with the filter rules among the filter rule set;
if there are filter rules matched, applying the matched filter rules to determine the validity of the intrusion alert;
if none of the filter rules is matched, determining the intrusion alert as invalid; and
filtering the intrusion alert determined invalid.

2. The method for eliminating invalid intrusion alerts of claim 1, wherein after determining whether there are alert features matched with the filter rules, the method further comprising:
determining whether there are multiple filter rules matched;
if there are multiple filter rules matched, applying the filter rule with the highest priority to determine the validity of the intrusion alert; and
if there is only one filter rule matched, applying the matched filter rule to determine the validity of the intrusion alert.

3. The method for eliminating the invalid intrusion alerts of claim 1, wherein the step of applying the matched alert filter to determine the validity of the intrusion alert comprises:
if the intrusion alert is rejected by the applied filter rule, determining the intrusion alert as invalid; and
if the intrusion alert is accepted by the applied filter rule, determining the intrusion alert as valid.

4. The method for eliminating the invalid intrusion alerts of claim 1, wherein the step of determining whether the IDS that generates the alert is cooperated with the firewall to protect the same network comprises:
if the intrusion alert is an alert generated by a predetermined IDS, determining it as “Yes”, otherwise, determining it as “No”.

5. The method for eliminating the invalid intrusion alerts of claim 1, wherein the step of converting the firewall rules into the filter rule set comprises:
extracting the communication protocol, the source IP address, the destination IP address, the source network service port, the destination network service port, the time, and the acceptance, rejection, and priority information from each firewall rule, so as to form a plurality of corresponding filter rules; and
combining the filter rules with the ID of the firewall to form the filter rule set.

6. The method for eliminating the invalid intrusion alerts of claim 1, wherein the alert features comprise the ID of the IDS, the communication protocol, the source IP address, the destination IP address, the source network service port, the destination network service port, and the time.

7. An on-line method for deploying the filter rule sets suitable for a security operation center to deploy a plurality of filter rule sets into a plurality of alert-collection hosts in remote sites, the method comprising:
recording a plurality of firewalls, IDSes, and alert-collection hosts managed by a security operation center in a registration table;
recording a plurality of firewall rules of the firewalls in a database;
converting the firewall rules of the firewalls into a plurality of filter rule sets;
recording the filter rule sets in the database; and
transmitting the filter rule sets to an alert filter of the corresponding alert-collection host according to the registration table.

8. The on-line method for deploying the filter rule sets of claim 7, wherein the registration table further comprises the following functions:
recording the relationship of whether the firewalls are cooperated with the IDS to protect the same network; and
recording the information of which IDS generating the alerts are received by the alert-collection hosts.

9. The on-line method for deploying the filter rule sets of claim 7, wherein the firewall rules are obtained from the firewall that is configured to detect the network attacks.

10. The on-line method for deploying the filter rule sets of claim 7, wherein the step of converting the firewall rules of the firewalls into a plurality of filter rule sets comprises:
extracting the communication protocol, the source IP address, the destination IP address, the source network service port, the destination network service port, the time, and the priority information from each firewall rule, so as to form the corresponding filter rules; and
combining the filter rules with the ID of the firewall to form the filter rule set.

11. The on-line method for deploying the filter rule sets of claim 7, further comprising when the firewall rules of the firewalls are changed, generating the corresponding updated filter rule sets by the security operation center.
